(19) United States
(12) Patent Application Publication
(10) Pub. No.: US 2005/0136376 A1
(43) Pub. Date: Jun. 23, 2005

(54) Method and apparatus for oral hygiene care

(76) Inventor: Richard T. Yeh, Arleta, CA (US)

Correspondence Address: RICHARD T. YEH, 13572 MONTAGUE STREET, ARLETA, CA, 91331, US

(21) Appl. No.: 10/739,682

(22) Filed: Dec. 19, 2003

(51) Int. Cl. A61C 17/06

(52) U.S. Cl. 433/91; 601/162

(57) ABSTRACT

A method and apparatus for oral hygiene care, for the removal of plaque and calculus build-up, and for the prevention of plaque and calculus formation on teeth is to reduce or eliminate susceptibility of dental and gum related disease. This method combines the oral irrigation, electrical power toothbrush and vacuum fluid, which can have synergistic effect on removal of plaque and food debris, and prevention of gum disease and tooth decay more efficiently.

### BACKGROUND OF THE INVENTION

I. Field of the Invention

The present intervention relates to a new method and apparatus for oral hygiene care, and in particular, to a new method and apparatus for interrupting and arresting the natural formation of plaque and calculus on teeth and tongue.

The most popular disease in human history is dental decay and gum disease. Dental decay and gum disease are caused by bacterial invasion which results in decomposition of bone around teeth and in teeth infection. Bacteria also decomposed the coating of top side of tongue and caused halitosis.

Gum disease, dental decay and halitosis can be prevented by good oral hygiene care and be treated.

II. Prior Art

At present, all kinds of oral hygiene care devices can't remove dental plague and food debris efficiently and effectively.

An electrical power toothbrush can't clean well enough on crowding teeth very effectively. Propelling pulsating jet stream of fluid may cause too much water in the mouth and sometimes will block out the airway.

### SUMMARY OF THE INTERVENTION

The present invention relates to a method and apparatus for oral hygiene care, which combines an electrical power toothbrush, water stream jet and suction device in one single system.

In the present invention, electrical power toothbrush head having plastic wings with a water stream jet tip attached it to can perform the tasks of cleaning simultaneously. Henceforth, the present invention will have synergistic action in the removal of dental plaque as compared to an electrical power toothbrush and a water stream jet in performing separate tasks.

At present, suction device which is combined with water stream jet machine can vacuum water, food debris and dental plaque at the same time. Therefore, the present invention can prevent excessive water from blocking the air way in the mouth.

### BRIEF DESCRIPTION OF DRAWING FIGURES

The invention is described in greater detail in the following description of an example embodying the best mode of the invention, taken in conjunction with the drawing figures, in which:

FIG. 1 is a front view of a system of oral hygiene apparatus

FIG. 2 is a top plan view electric toothbrush

FIG. 3 is a side view electric toothbrush

FIG. 4 is FIG. 3 attach with irrigation nozzle tip and fluid conduit

FIG. 5 is a top view of FIG. 1 with fluid container removed

### DETAILED DESCRIPTION OF THE INVENTION

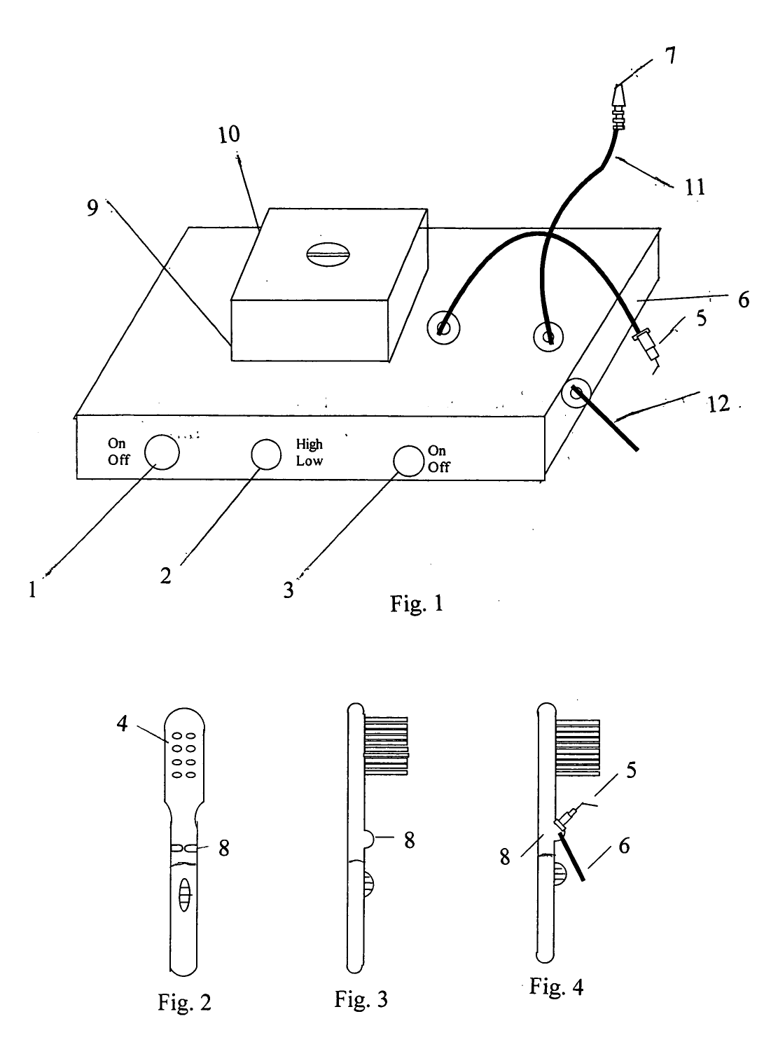

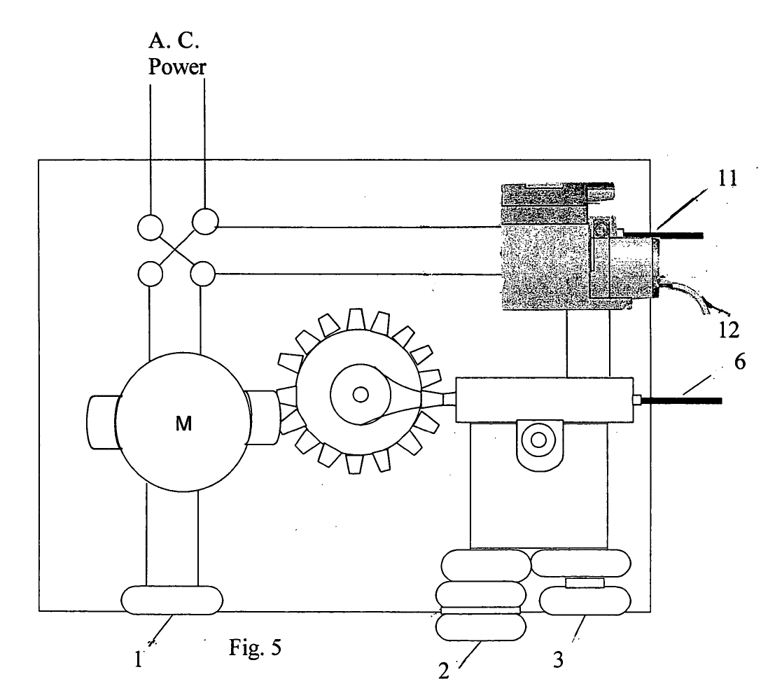

A system for oral hygiene care apparatus as shown in FIG. 1, FIG. 2, FIG. 3, FIG. 4, and FIG. 5 is typical of those employing techniques of applying to the teeth and gums. An electrical toothbrush head, 4 (FIGS. 2, 3 and 4) with wings, 8 (FIGS. 2, 3, and 4) that oral irrigator nozzle tip, 5 (FIG. 4) along with water fluid conduit, 6 (FIGS. 4 and 5) attached on will operate brushing of the teeth, irrigating and massaging the gums simultaneously. When water fluid is full in the mouth, turn on power switch, 3 (FIG. 1), then suction tip, 7 (FIG. 1), along with vacuum inlet conduit, 11 (FIGS. 1 and 5) will vacuum the water fluid, food debris and dental plague into sink through outlet conduit, 12 (FIGS. 1 and 5). The power switch knob, 1 (FIGS. 1 and 5), is to control oral irrigation power and the pulse rate control knob, 2 (FIGS. 1 and 5), is to control pulse rate strength.

1. A method of oral hygiene care will provide cleaning teeth and tongue, and vacuum the fluid and debris simultaneously.

2. To accomplish the method of oral hygiene care is by a set of apparatuses within an oral hygiene care unit, comprising an electrical power toothbrush, a water jet unit and a vacuum unit into a single system.

3. Apparatus according to claim 2, wherein said an electrical power toothbrush has wings which a water jet tip can snap and attach on.

4. Apparatus according to claim 2, wherein said a water jet machine combines a vacuum unit into a single circuit board.
